(19) United States
(12) Patent Application Publication
(10) Pub. No.: US 2015/0139249 A1
(43) Pub. Date: May 21, 2015

(54) System and Method for Debugging

(71) Applicant: Emulex Corporation, Costa Mesa, CA (US)

(72) Inventors: Shiro Suzuki, Folsom, CA (US); Kameshwar Chavali, Austin, TX (US); Subbu Muddappa, Fremont, CA (US); Sarangan Padalkar, San Jose, CA (US); Jayachandra Avula, Cupertino, CA (US); Chakradhara Aradhyula, San Jose, CA (US); Kameron Ayati, San Ramon, CA (US); Phani Chandrupatla, San Jose, CA (US)

(73) Assignee: Emulex Corporation, Costa Mesa, CA (US)

(21) Appl. No.: 14/083,819

(22) Filed: Nov. 19, 2013

(51) Int. Cl. H04L 29/06

(52) U.S. Cl. CPC H04L 69/04
USPC 370/474

(57) ABSTRACT

A system and method for debugging an ASIC are described herein. In accordance with this disclosure, a trigger logic unit may trigger a transfer of a multi-bit signal from an internal ASIC state to a compression engine. The compression engine may compress the multi-bit signal to create a compressed signal. A packet engine may packetize the compressed signal for transmission via a debug interface.

### FIELD

The disclosure relates to the field of debugging an ASIC (Application Specific Integrated Circuit). In particular, but not exclusively, it relates to a system and method operable to provide a compressed, packetized data stream for a debug bus coupled to the internal state of an ASIC.

### BACKGROUND

A common solution for debugging is to send a parallel debug bus to the output of an ASIC. However, with smaller chip architectures, this solution has several limitations. Primarily, the parallel debug bus requires the input/output of the ASIC to support high frequency data transfer. As the debug bus frequency increases, it becomes increasingly harder to meet timing requirements using common CMOS output circuitry.

A serial port (e.g., UART) may access an ASIC's internal status. However, the amount of information available to the serial port may be less than any parallel debug bus at the same clock frequency. Alternatively, a JTAG port may be cumbersome and may not have access to the dynamic state of an ASIC.

Further limitations and disadvantages of conventional and traditional approaches will become apparent to one of skill in the art, through comparison of such systems with the present disclosure as set forth in the remainder of the present application with reference to the drawings.

### BRIEF SUMMARY

Aspects of the present disclosure are aimed at a system and method for debugging an ASIC. In accordance with this disclosure, a trigger logic unit may trigger a transfer of a multi-bit signal from an internal ASIC state to a compression engine. The trigger logic unit may comprise a pointer generator operable to generate a read or write control signal for the transfer of the multi-bit signal. The compression engine may compress the multi-bit signal to create a compressed signal. The compression engine may comprise a history buffer for the storage of a previous multi-bit signal. A packet engine may packetize the compressed signal for transmission via a debug interface. A Ping-Pong FIFO buffer may transfer packets between the compression engine and the packet engine. The packet engine transmits the packet out on a high speed serial interface such as Ethernet or PCI express.

One example embodiment of this disclosure comprises a hardware debug ring that may provide access to the internal ASIC state. In another example embodiment of this disclosure, the debug interface comprises an Ethernet MAC layer processor and/or a physical coding sub-layer.

### BRIEF DESCRIPTION OF SEVERAL VIEWS OF THE DRAWINGS

The disclosure will now be described in greater detail with reference to accompanying figures, in which:

FIG. 1 is a block diagram of a system operable to provide a debug bus for real time debugging of an ASIC according to one or more example embodiments of the present disclosure.

FIG. 2 is a flow diagram of a method for providing a debug bus for real time debugging of an ASIC according to one or more example embodiments of the present disclosure.

FIG. 3 is a block diagram illustrating the debug interface between an ASIC and an FPGA according to one or more example embodiments of the present disclosure.

FIG. 4 is a block diagram of a system operable to provide a debug bus for real time debugging of an ASIC according to one or more example embodiments of the present disclosure.

FIG. 5 illustrates an IP packet header according to one or more example embodiments of the present disclosure.

### DETAILED DESCRIPTION

This disclosure provides a system and method that may provide real-time debug functionality, by generating a compressed, packetized data stream over a debug bus that is coupled to the internal state of an ASIC. The ASIC may be used in a LAN on Motherboard (LOM), Mezzanine card, production standup card or other applications.

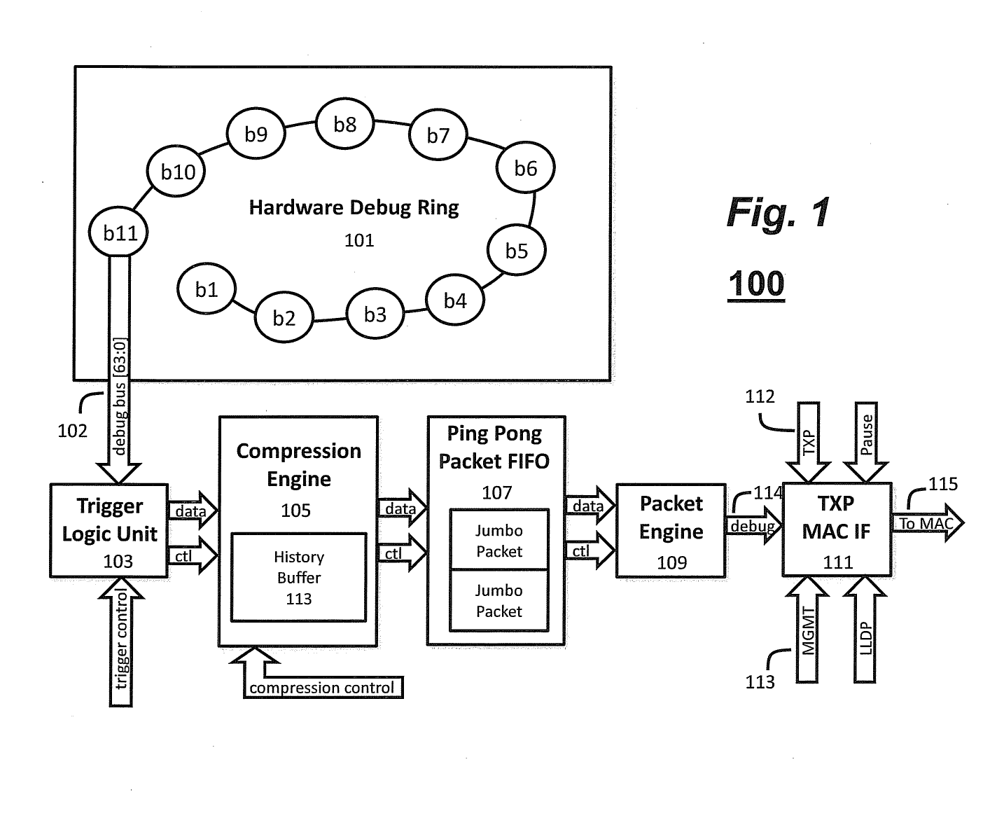

FIG. 1 is a block diagram of a system 100 operable to provide a debug bus for real time debugging of an ASIC according to one or more example embodiments of the present disclosure. The system 100 comprises a Hardware Debug Ring 101, a Trigger Logic Unit 103, a Compression Engine 105, a Ping Ping-Pong FIFO buffer 107, a Packet Engine 109 and a Transmit Path MAC Interface 111.

The Hardware Debug Ring 101 may connect to one or more registers to provide an internal state of the ASIC in the form of a debug bus 102 (e.g. a 64-bit debug bus). While a 64-bit bus is illustrated, the datawidth may also be larger or smaller. In case the ASIC has multiple clock domains, the Hardware Debug Ring 101 may have an accompanying clock signal. The Trigger Logic Unit 103 may also perform the clock rate conversion if the Hardware Debug Ring 101 has an accompanying clock signal.

The Trigger Logic Unit 103 may supply a sophisticated triggering scheme or a conventional triggering scheme to the debug bus. The triggering scheme may be indicated by the trigger control input to the Trigger Logic Unit 103. This disclosure provides sophisticated triggering schemes and mechanisms, such as a multi-level trigger and a state-machine type trigger. The trigger status may be passed, as the ctl output, from the Trigger Logic Unit 103 to the Compression Engine 105.

The Compression Engine 105 comprises a history buffer 113 for storage, which may be necessary for some compression schemes. The Compression Engine 105 may compress a stream of data. This disclosure provides real-time, lossless compression that allows normal traffic to co-exist with debug traffic. For example, a raw bandwidth of almost 40 Gbps may be converted to less than 10 Gpbs. The level of compression may be controlled via the compression control input to the Compression Engine 105. The trigger status may be passed, as the ctl output, from the Compression Engine 105 to the Ping-Pong FIFO buffer 107.

The lossless compression technique (e.g., Lempel-Ziv-Welch (LZW)) may compress an incoming stream of the debug bus 102. This allows compression at a very high rate, particularly since the debug bus 102 may comprise many static values. The high rate of compression enables the communication of a compressed data-gram on an active port at a rate much less than the required rate. For example, 64 bits @ 600 MHz would typically require 38.4 Gbps, and compression may reduce the data rate requirement to less than 10 Gbps.

The compressed data may be pushed into the Ping-Pong FIFO buffer 107. The Ping-Pong FIFO buffer 107 is a buffer and/or stack that comprises storage for two jumbo packets (e.g., 9 kbytes each). As known in the art, the Ping-Pong FIFO buffer 107 advantageously allows one jumbo packet to be written while the other jumbo packet is read. The trigger status may be passed, as the ctl output, from the Ping-Pong FIFO buffer 107 to the Packet Engine 109.

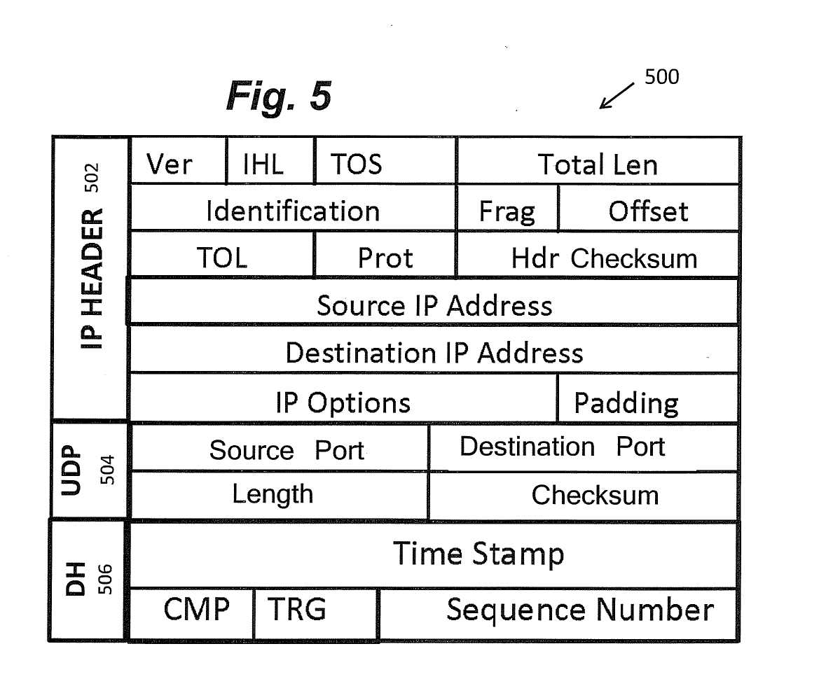

The Packet Engine 109 may packetize the compressed data. For example, when the Ping-Pong FIFO buffer 107 fills up, an Ethernet and/or an IP Header may be added to the data in the FIFO. A programmable debug header which includes a timestamp and indicates the trigger status may be further added after the Ethernet and/or IP header. An example programmable debug header is further described below and in relation to FIG. 5.

Alternatively, the compression engine 105 and/or the Ping-Pong FIFO buffer 107 may be bypassed. The trigger logic unit 103 may be directly coupled to the Ping-Pong FIFO buffer 107 if the compression engine 105 is bypassed. The trigger logic unit 103 may be directly connected to the Packet Engine 109 if the compression engine 105 and Ping-Pong FIFO buffer 107 are bypassed.

Since the packets have completely programmable Ethernet/IP headers, this disclosure allows the use of a programmable debug header, which may be based on the trigger mechanism chosen. This allows a multiple level type trigger and state-machine type trigger. The Packet Engine 109 is operable to prepend the programmable debug header to a packet. The programmable debug header may comprise a trigger location. The Packet Engine 109 may be operable to add a timestamp and a packet sequence number to the one or more output packets.

The Transmit Path MAC Interface 111 may comprise a MAC layer processor. This debug interface may also comprise a physical coding sub-layer and a serializer/deserializer (SERDES).

The Transmit Path MAC Interface 111 may send out the compressed packet on a dedicated port or on an active port inter-mixed with regular traffic. A co-existence with existing infrastructure, whereby debug packets are inter-mixed with regular traffic, may result in an ASIC architecture where no new ports or interfaces are added to support debug activity. The Transmit Path MAC Interface 111 may take input from a User Data Transmit Path (TXP) input 112 and/or a management (MGMT) input 113. The Transmit Path MAC interface 111 may arbitrate between User Data TXP input 112, management input 113 and debug packet input 114.

By compressing a stream of 64-bit data, applying disclosed triggering schemes, and packetizing the data, debug capabilities are available at locations where it may otherwise be very difficult to debug. This disclosure provides a solution that allows access to an internal state of the ASIC on a cycle-by-cycle basis, without having to use expensive logic analyzers, high speed interconnects and/or specific evaluation boards.

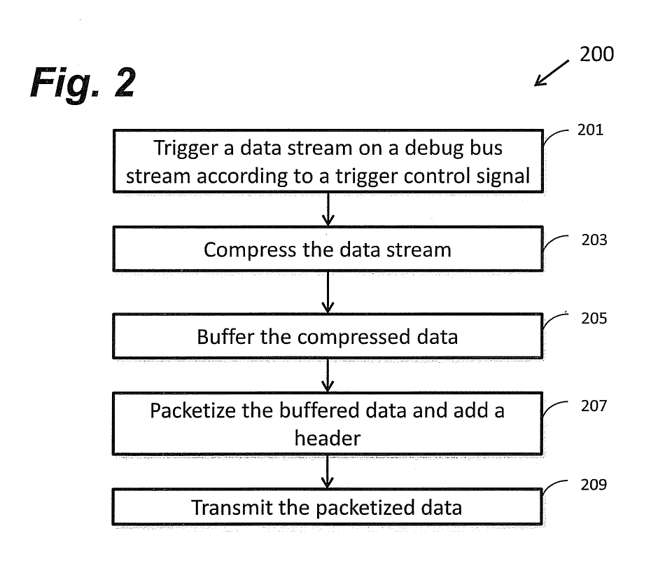

FIG. 2 is a flow diagram of a method 200 for providing a debug bus for real time debugging of an ASIC according to one or more example embodiments of the present disclosure. At block 201, a data stream on a debug bus is triggered according to a trigger control signal. The triggering may occur in the Trigger Logic Unit 103 in FIG. 1, for example. At block 203, the data stream is compressed. The compression may occur in the Compression Engine 105 in FIG. 1, for example. At block 205, the compressed data is buffered. The buffering may occur in the Ping-Pong FIFO buffer 107 in FIG. 1, for example. At block 207, the buffered data is packetized and a header is added. The packetization may occur in the Packet Engine 109 in FIG. 1, for example. At block 209, the packetized data is transmitted. The transmission interface may be the Transmit Path MAC Interface 111 in FIG. 1, for example.

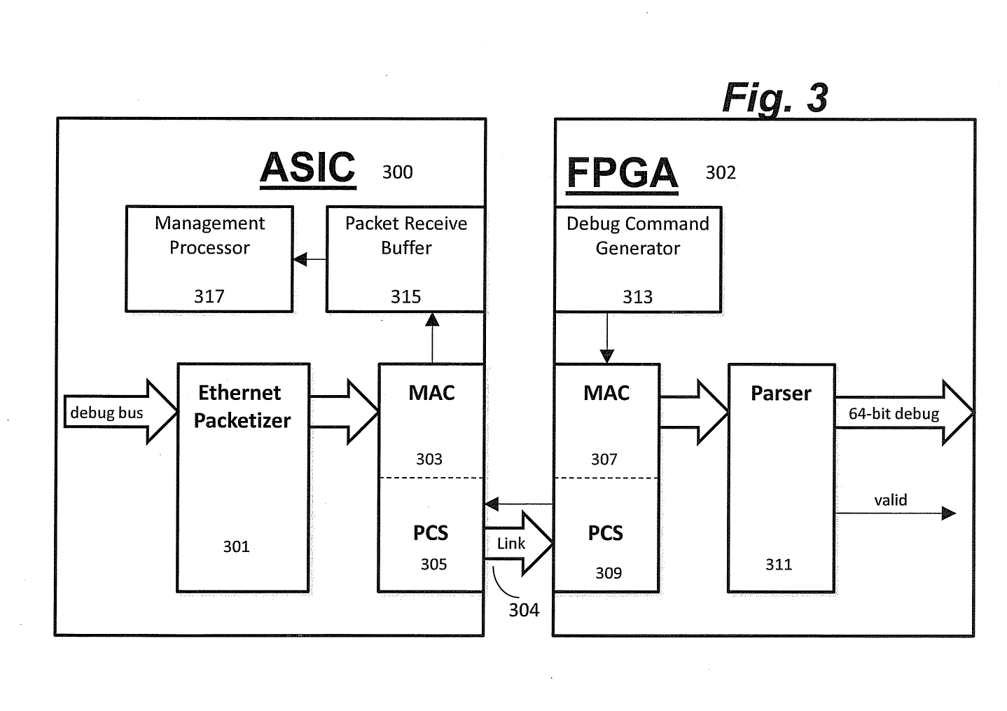

FIG. 3 is a block diagram illustrating the debug interface between an ASIC 300 and a field-programmable gate array (FPGA) 302 according to one or more example embodiments of the present disclosure. In one implementation, the ASIC 300 is configured for network communications via a link 304, e.g. a 40 Gb Ethernet link. In some embodiments, the ASIC 300 is a network controller, which requires debugging. In these embodiments, the FPGA 302 may be part of a system or tool for advantageously debugging the ASIC 300. The FPGA 302 may be coupled to the ACIS 300 via the link 304. On the ASIC 300 of FIG. 3, data over the debug bus may be framed by the Ethernet Packetizer 301. Data may be communicated over a 64-bit debug bus at 600 MHz. Packet size may be programmable, but is constant for all packets. For example, the Ethernet packet may comprise as few as 64 bytes or as many as 9,000 bytes. The Ethernet packet may comprise a header and a cyclic redundancy check (CRC).

The header for all Ethernet packets, regardless of packet size, may comprise a destination MAC address, a source MAC address, a type/length field and user data. If the type/length field has a value 1500 or lower, the type/length field indicates the length of the user data. If the type/length field has a value greater than 1500, the type/length field is followed by data for an upper layer protocol. The user data may comprise header bytes for different protocol layers and trailer bytes. For example, the header bytes for an IPv4 header may comprise the IP header 502 in FIG. 5. The trailer bytes may comprise 4 bytes of status and trigger.

The Ethernet packets may be sent to the Media Access Control (MAC) layer 303 and Physical Coding Sub-layer (PCS) 305 before being transmitted from the ASIC 300. A 1 K-byte buffer may be used to capture debug input. Therefore, data transmission may start before the buffer is full, thereby allowing for larger than 1K packet size.

The PCS 305 of the ASIC 300 is coupled to the PCS 309 of the FPGA 302 via an Ethernet protocol and connection. For example, 40 gigabit per second Ethernet may be used. This enables debugging in a customer environment. This also allows the debug packets to be routed to any location in the world, captured and analyzed. Remote real-time debugging may be particularly useful where it may be hard to use a logic analyzer to view internal debug signals. This solution may allow complete access to the debug bus where remote real-time debugging has conventionally been difficult.

On the FPGA 302 of FIG. 3, the Ethernet packets received at the PCS 309 can then be sent to the MAC layer 307 of the FPGA 302. Data may then be parsed in the FPGA 302 and framed by the Parser 311 to recreate the 64-bit data that carries the debug information. A valid signal may also be output from the Parser 311 to indicate the presence of debug information. When the triggered packet is uncompressed and unpacketized, the raw data may be converted to any format. Formats include, but are not limited to, Value Change Dump (VCD) and Fast Signal Database (FSDB).

Further the FPGA 302 may contain a Debug Command Generator 313, which connects to the MAC 307 transmit output. The Debug Command Generator 313 may be used to send debug command packets to the ASIC 300. The ASIC 300 may receive such debug command packets into a Packet Receive Buffer 315. The Packet Receive Buffer 315 may be the same receive buffer which is used to handle Ethernet control protocols such as LLDP. A Management Processor 317 may decode the debug command packets and control the Trigger Logic Unit 103 of FIG. 1. This may allow for dynamic debugging setup changes.

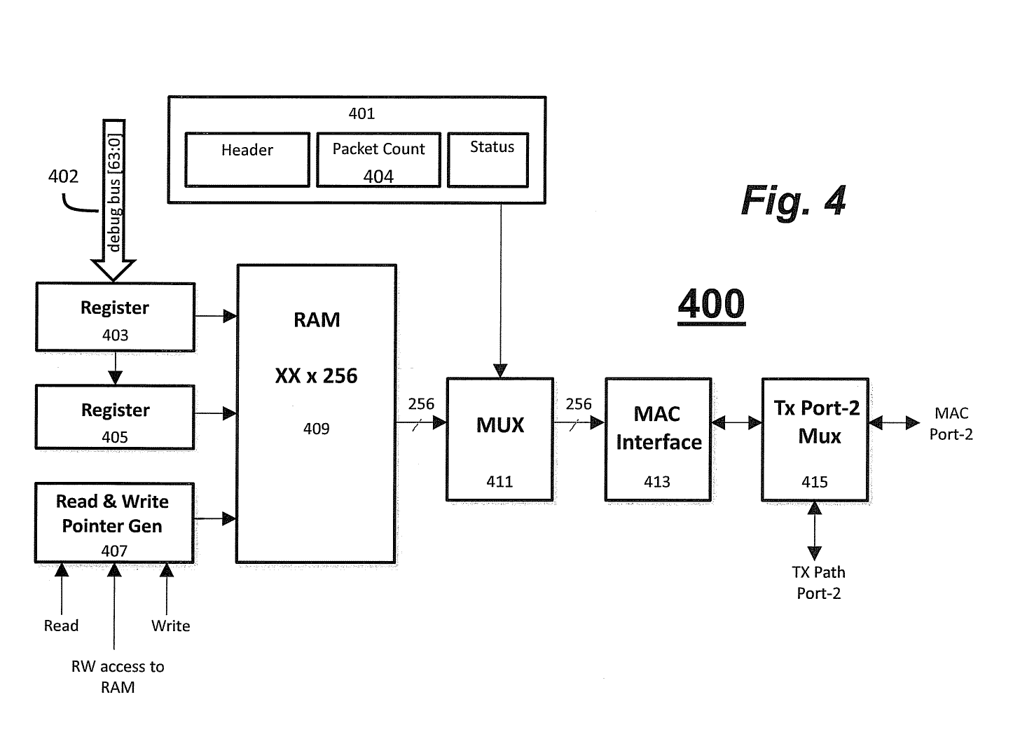

FIG. 4 is a block diagram of a system 400 operable to provide a debug bus 402 for real time debugging of an ASIC according to one or more example embodiments of the present disclosure. In the case of Ethernet, the IP packet may be wrapped in a MAC packet 401 (e.g., 14 byte header+4 byte CRC) with a packet count 404. Data from the debug bus may be transferred to a register 403 (e.g., a 64-bit register). In order to use a single port RAM for RAM 409, a register 405 (e.g., a 192-bit register) may store a history of three data transfers from the register 403. The RAM 409 may sink all raw data written. The RAM 409 may store the debug bus packet generator input. The MUX 411 receives the debug bus packet header from the MAC packet 401 and then subsequently reads the debug data from the RAM 409. All debug block chains may run on free-running clock and/or clock-gating on those chains is disabled to ensure the debug bus 402 is always valid. Clock domains involved in debug chains may be isolated to make it simpler for backend layout as well as to support live sampling off chip. The RAM 409 may be controlled by a pointer generated by a Read & Write Pointer Generator 407. The Read & Write Pointer Generator 407 may be part of the Trigger Logic Unit 103 in FIG. 1, for example.

In one implementation, the RAM 409 may input 256 bit data to a multiplexor 411. The multiplexor 411 may input the 256 bit data to a MAC Interface 413. The MAC Interface 413 may input data packets to a Transmit Port-2 multiplexor 415, which selectivity communicates data to a MAC or a Transmit Path via respective ports. The MAC Interface 413 may also receive external input, via the Transmit Port-2 multiplexor 415, from the MAC and/or Transmit Path.

Modes in which the debug bus may operate include Stop, Trigger, Valid, Sample_Data, Trigger_in and Trigger_out. Stop mode may indicate an end of a capture. Trigger mode may indicate that the current sample matches trigger conditions as identified in the packet header. Valid mode may indicate the validity of data on the ‘sample data’ bus. Sample_Data mode may output the current samples collected. Trigger in mode may indicate that a matching condition has been met, and a trigger may be strobed. Trigger out mode may be used for cross triggering.

FIG. 5 illustrates an IP packet 500 according to one or more example embodiments of the present disclosure. In this example, the IP packet 500 comprises an IP header 502, a UDP header 504 and a debug header 506. An example IP header 502, which in this case is the IPv4 packet header, comprises 14 fields, of which 13 are generally required. With the 13 fields, the IP header 502 is 20 bytes. The 14th field is optional and results in a 21 byte header. The IPv4 packet header comprises bits for indicating a version (Ver), an Internet Header Length (IHL), a Type of Service (TOS), a total length (Total Len), an identification, a fragmentation (Frag), a fragment offset (Offset), a time to live (TOL), a protocol type (Prot), a header check sum (Hdr Checksum), a source IP address and a destination IP address.

The User Datagram Protocol (UDP) header 504 in FIG. 5 comprises of 4 fields (Source port, Destination port, Length and Checksum) each of which is 2 bytes (16 bits). The use of the fields “Checksum” and “Source port” is optional in IPv4. In IPv6 only the “Source port” is optional. An IP packet 500 with an empty UDP datagram as payload takes at least 28 bytes (IPv4) or 48 bytes (IPv6), but may take more bytes. The Packet Engine 109 of FIG. 1 may modify parts of the Source port, destination port and update the Checksum so that the work load of receiving high speed debug stream can be split between multiple receivers.

As shown in FIG. 5, the debug header (DH) 506 is advantageously appended to the IP header 502 and UDP header 504 described above. The debug header 506 is advantageously programmable and comprises several fields: a timestamp, an indication of whether compression, e.g., via the Compression Engine 105 of FIG. 1, is enabled (CMP), a trigger indication (TRG) and a sequence number. The timestamp indicates when the data was captured. The timestamp may be a 32-bit Real Time Clock output, for example.

The CMP indicator field may take the following values: 0x0 for no compression; 0x1 for simple repeat compression; 0x2 for LZW type compression using a history buffer scheme; and 0x3 may be reserved. The history buffer scheme may use the history buffer 113 in the Compression Engine 105 as illustrated in FIG. 1, for example. The history buffer scheme may be based on changes in the input data and/or changes in the compressed data.

The Trigger Enable (TRG) field may take the following values: 0x0 for not triggered; 0x1 to indicate a first level trigger is valid; 0x2 to indicate a second level trigger is valid; and 0x3 to indicate a third level trigger is valid.

Sequence numbers are important since the Ethernet protocol is lossy and does not guarantee order and may not be reliable. The Sequence Number may start upon an enabling event and keep incrementing for every packet that is sent out.

After the programmable debug header the debug data from the Compression Engine 105 will be appended.

The present disclosure may be embedded in a computer program product, which comprises all the features enabling the implementation of the example embodiments described herein, and which when loaded in a computer system is able to carry out these example embodiments. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present disclosure has been described with reference to certain example embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular example embodiment disclosed, but that the present disclosure will include all example embodiments falling within the scope of the appended claims.

What is claimed is:

1. A system operable to enable debugging, comprising:
a trigger logic unit operable to trigger a transfer of a multi-bit signal from an internal ASIC state to a packet engine; and
the packet engine operable to packetize the multi-bit signal into one or more output packets for transmission via a debug interface, wherein the packet engine is operable to add one or both of a timestamp and a packet sequence number to the one or more output packets.

2. The system of claim 1, wherein the system comprises a compression engine operable to compress the multi-bit signal.

3. The system of claim 2, wherein the compression engine comprises a history buffer for the storage of a previous multi-bit signal.

4. The system of claim 2, wherein the system comprises a Ping-Pong FIFO buffer operable to transfer packets between the compression engine and the packet engine.

5. The system of claim 1, wherein the internal ASIC state is accessible via a hardware debug ring.

6. The system of claim 1, wherein the debug interface comprises a MAC layer processor.

7. The system of claim 1, wherein the debug interface comprises a physical coding sub-layer.

8. The system of claim 1, wherein the debug interface comprises a SERDES.

9. The system of claim 1, wherein the debug interface is coupled to a transmit path port.

10. The system of claim 1, wherein the packet engine is operable to prepend a programmable header.

11. The system of claim 10, wherein the programmable header comprises a trigger location.

12. The system of claim 1, wherein the trigger logic unit comprises a pointer generator operable to generate a control signal for the transfer of the multi-bit signal.

13. A method for debugging, comprising:
transferring a multi-bit signal from an internal ASIC state;
generating a timestamp and a packet sequence number;
packetizing the multi-bit signal, the timestamp and the packet sequence number, thereby generating one or more output packets; and
transmitting the one or more output packets via a debug interface.

14. The method of claim 13, wherein the internal ASIC state is accessible via a hardware debug ring.

15. The method of claim 13, wherein the method comprises compressing the multi-bit signal according to a previous multi-bit signal.

16. The method of claim 13, wherein the method comprises transferring the multi-bit signal via a Ping-Pong FIFO buffer.

17. The method of claim 13, wherein the debug interface comprises a MAC layer processor.

18. The method of claim 13, wherein the method comprises receiving debug command packets and triggering the transfer of the multi-bit signal from the internal ASIC state according to the receive debug command packets.

19. The method of claim 13, wherein the debug interface is coupled to a transmit path port.

20. The method of claim 13, wherein triggering a transfer of the multi-bit signal comprises generating a control signal.
